(19) United States
(12) Patent Application Publication
(10) Pub. No.: US 2003/0156913 A1
(43) Pub. Date: Aug. 21, 2003

(54) Apparatus for forming threads in a pipe end

(76) Inventor: Ronnie M. Willis, Jackson, TN (US)

Correspondence Address: MANELLI DENISON & SELTER, 2000 M STREET NW SUITE 700, WASHINGTON, DC, 20036-3307, US

(21) Appl. No.: 10/153,866

(22) Filed: May 24, 2002

Related U.S. Application Data
(60) Provisional application No. 60/357,633, filed on Feb. 20, 2002.

(51) Int. Cl. B23G 1/22

(52) U.S. Cl. 409/74

(57) ABSTRACT

A pipe end thread cutting apparatus includes three milling cutter heads mounted on a support wall which is vertically movable with the heads mounted symmetrically about a central axis in use; a gripping chuck for holding a pipe end is mounted on a rotatable shaft carried on a support member which is movable toward and away from the milling cutter heads and motor drives are provided for each cutter head.

### BACKGROUND OF THE INVENTION

This invention relates to thread milling devices, especially thread milling devices for forming threads and the like in the periphery of a pipe end for connecting and retaining the pipe to a coupling or other fluid conducting member. A particular example of the present invention relates to forming threads and the like in a pipe end to make a pipe nipple. In past practice in the fluid conduit field, threads were cut in the ends of pipes to enable connection to other elements of a system such as valves, joints and the like. Equipment for cutting straight threads (i.e., threads that lie a uniform radial distance from the axis of the pipe) has been in widespread use for many years.

However, the advantages of forming tapered threads (i.e., threads that vary in radial distance from the axis of the pipe) on pipe ends have become apparent, but equipment for forming tapered threads is difficult to set up, slow to operate, and expensive to acquire. An example of a pipe nipple having tapered threads is illustrated in FIG. 5 at 70. Since the desirable characteristics of tapered thread nipples have increased demand for these types of pipe ends, there exists a need for an improved apparatus for quickly and accurately forming tapered threaded pipe ends that can be threaded into associated conduit elements to assure fluid tight seals.

### BRIEF DESCRIPTION OF THE DRAWINGS

FIG. 1 is a side view of an apparatus provided in accordance with the principles of the present invention;

FIG. 2 is an enlarged side view of the apparatus illustrated in FIG. 1;

FIG. 3 are end views of opposing portions of the apparatus according to the present invention;

FIG. 4 is a plan view of a dual apparatus according to the present invention; and

FIG. 5 is a side view of an exemplary conventional pipe nipple having tapered threads formed on a periphery thereof.

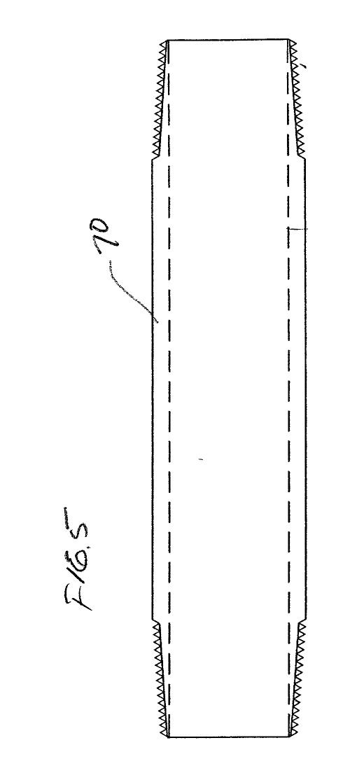

FIG. 6 is an enlarged sectional view of two of the thread forming cutters used in the invention.

### DETAILED DESCRIPTION OF THE INVENTION

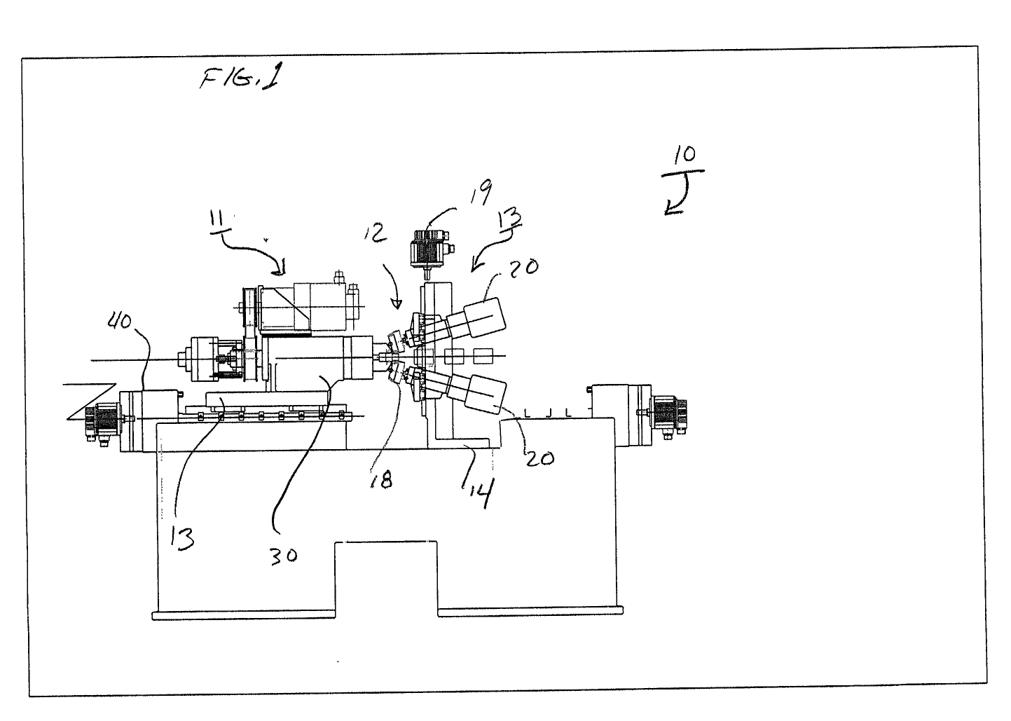

Referring to FIG. 1, a thread cutting apparatus for cutting threads in pipe nipples is shown, generally indicated at 10, provided in accordance with the principles of the present invention. Reference to the term “thread” or “threads” herein is meant to include, without limitation, both a helical structure for permitting rotational engagement (like a screw, for example) and one or more circumferentially extending structures for permitting axial press-fitting between members.

The apparatus 10 includes a pipe holding portion, generally indicated at 11, and a milling head portion, generally indicated at 13.

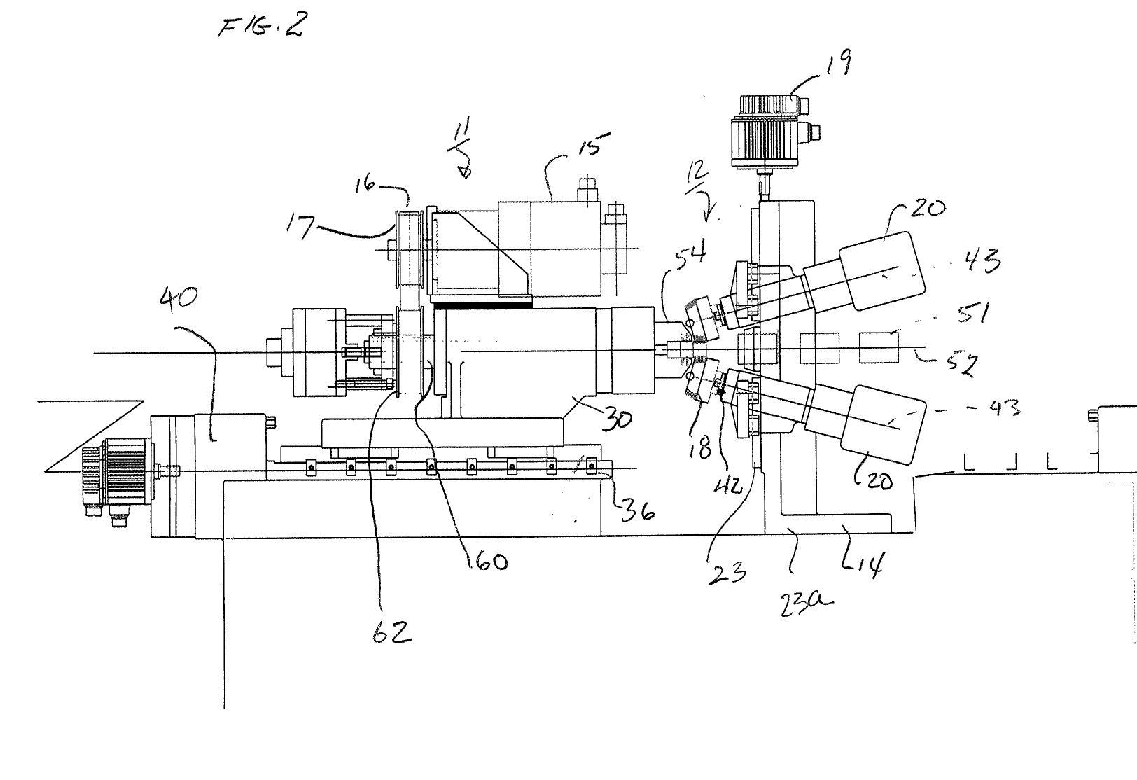

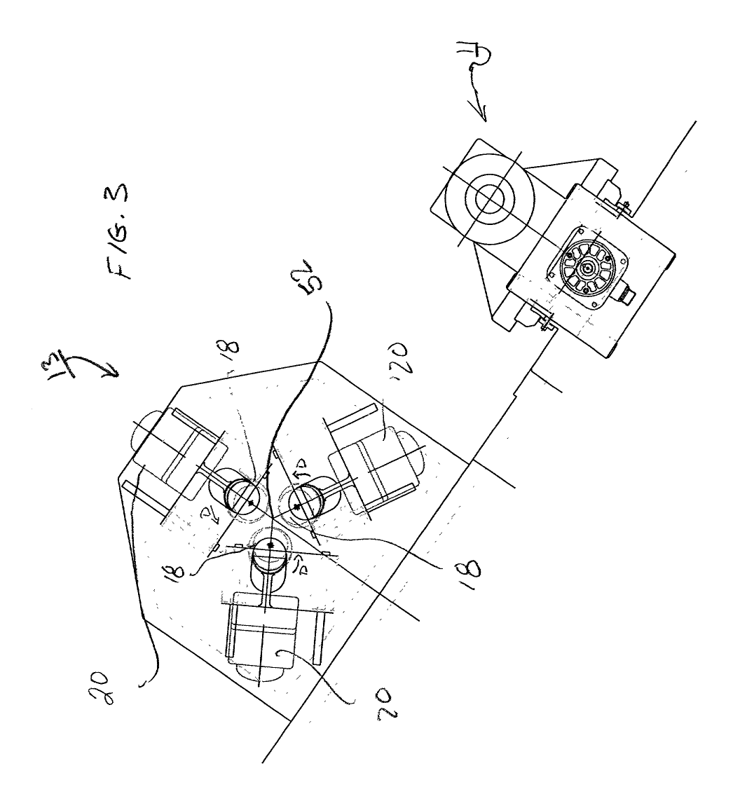

The milling head portion includes a thread milling head, generally indicated at 12, mounted on a vertical platform 14. The thread milling head 12 includes thread milling cutters 18. Three thread milling cutters 18 are illustrated (see, for example, FIG. 3) strictly by way of example, and the number of thread milling cutters 18 that may actually be provided may vary as needed. Each thread milling cutter 18 is constructed in a known way to form a desired thread on the end of a pipe held in pipe holding portion 11 (as discussed below). Each thread milling cutter 18 is arranged to rotate about an associated shaft 42 (having axis of rotation 43) in the direction of arrow D (see, for example, FIGS. 2 and 3). The thread milling cutters 18 rotate in the same rotational direction and may be driven to rotate in a known manner, including, without limitation, being independently driven (for example, by a conventional motor housed in respective housings 20), and being synchronously driven, such as by one or more drive belts (not shown) engaged with the respective thread milling cutters 18 and with a single conventional drive motor (not shown). The motor (or motors) provided may be a servo motor controllably driven in a known manner using computer numeric control (CNC) methods.

In addition, the thread milling head 12 (including the provided thread milling cutters 18) may be rotatably mounted about axis 52 with respect to platform 14. Thread milling head 12 may be supported by a bearing structure, such as that shown schematically in FIG. 2 at 51. Thread milling head 12 may be driven to rotate about axis 52 by drive motor (not shown) in a known manner, such as by way of a timing belt engaged therebetween similar to that shown on the left hand side of holding portion 11.

In an example of the present invention, thread milling cutters 18 are mounted so that their axes of rotation 43 are not parallel with axis 52. In a particular example of the present invention, the axes of rotation of the respective thread milling cutters 18 are arranged so as to intersect at substantially the same point along axis 52. The angle between axes 43 and axis 52 may be selectively adjustable in order to, for example, accommodate pipes of different diameters, or to selectively move the thread milling cutters 18 between a first position in which the pipe is arranged to be worked on and a second position in which the thread milling cutters are placed into position relative to the pipe for forming the desired threads.

In order to further control the position of the thread milling head 12 relative to the pipe holding portion 11, the vertical position of the thread milling head 12 may be controlled, for example, by a servo motor 19 which may operate a screw feed to raise or lower the platform 23 slidably mounted on column 23a.

The pipe holding portion 11 holds a pipe segment being operated on. The pipe holding portion 11 is provided on a support 13. The support 13 in the form of a plate and is in turn laterally movable relative to the platform 14 by way of, for example, a precision slide mechanism 36 (see, for example, FIG. 2). The lateral position of support 13 (with pipe holding portion 11 provided thereon) relative to platform 14 may be automatically controlled by motor 40 connected to support 13 by a known linkage, such as a ball screw mechanism. In an example of the present invention, motor 40 may be a CNC servo motor to provide precise control of the position of pipe holding portion 11 relative to platform 14.

Pipe holding portion 11 also includes a housing 30 that contains a chuck, spindle, or other mechanism 54 for selectively retaining a pipe segment therein during the process of thread cutting. The chuck 54 is arranged so as to hold a pipe segment (not shown) therein substantially coaxial with axis 52 of the milling head 12 (see, for example, FIG. 2). The chuck 54 may be either manually actuable, automatically actuable, or both, in accordance with known practices.

Chuck 54 is mounted on a rotatable shaft 60. Shaft 60 is mounted within housing 30 so as to be rotatable (for example, on one or more rotational bearings provided within housing 30 and not shown here). A pulley 62 is fixedly mounted on shaft 60. Pipe holding portion 11 also includes a drive motor 15 arranged to drive a pulley 17 in rotation. Pulleys 17 and 62 are engaged in a known manner, such as by a belt 16 extending therebetween. Therefore, drive motor 15 is operable to drive shaft 60, and in turn, chuck 54, in rotation. Drive motor 15 may be a CNC servo motor.

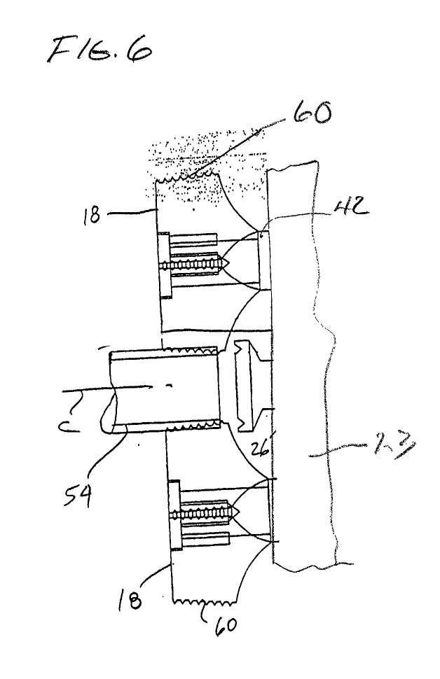

As best shown in FIG. 6, the thread milling cutters 18 are arranged about axis 52 to receive the end of a pipe segment therebetween and to cut threads in an exterior periphery of the pipe segment. Each thread milling cutter 18 carries multiple, generally circumferentially extending teeth 60 for cutting threads in the periphery of a pipe segment upon simultaneous rotation of the milling cutters 18 about their associated shafts, and rotation of the entire thread milling head 12 about axis C. The thread milling cutters 18 can be changed for cutting tapered or straight threads. In FIG. 3, the end of the pipe holding portion 11 facing the milling head portion 13 is illustrated schematically to simplify the drawing. In FIG. 3, the pipe holding portion 11 and milling head portion 13 are illustrated as being placed on an inclined surface as is sometimes done in the field of milling. However, it is not necessary to provide the apparatus on an inclined surface.

In this regard, certain structural parameters can be varied as desired, depending on the degree of tapering in the threads, the pitch of the threads, etc. For example, the teeth of a thread milling cutter 18 may be provided on a frusto-conical surface. Therefore, for example, one or both of the angles between the frusto-conical surface and respective axis 43, and the angle between axis 43 and axis 52 can be varied.

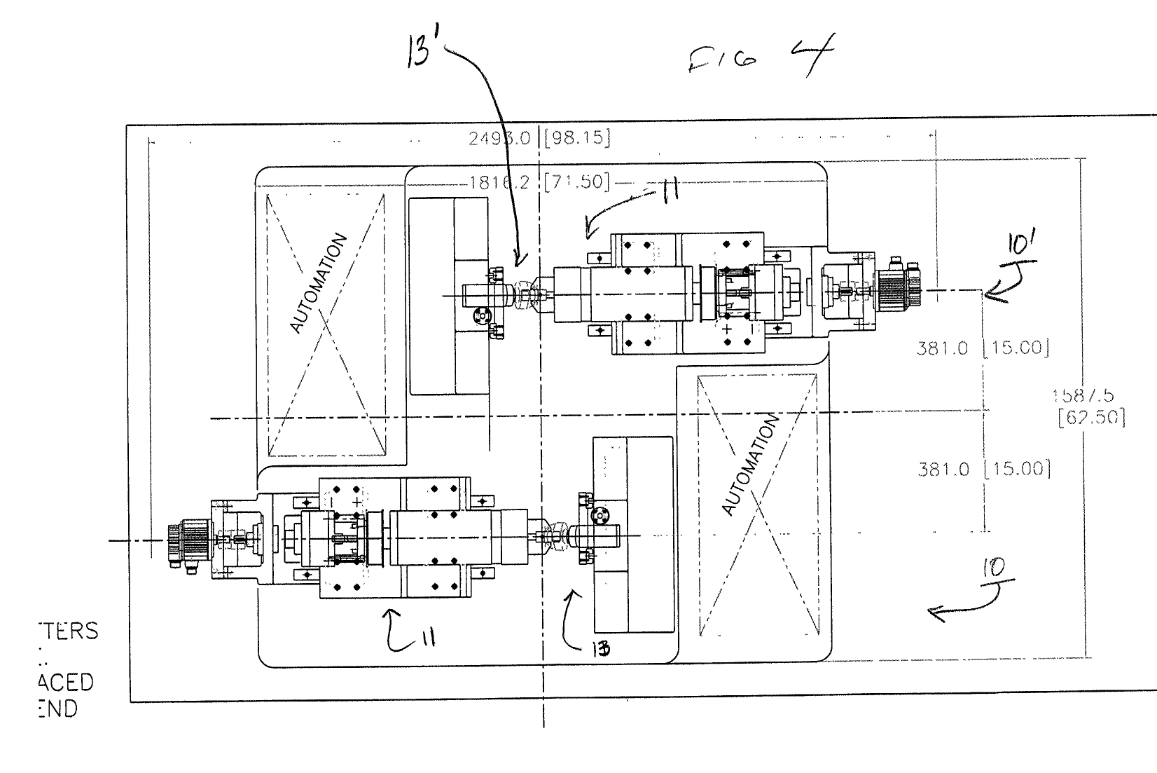

FIG. 4 illustrates an embodiment of the present invention for forming threads on both ends of a pipe segment. As seen in FIG. 4, two apparatuses 10, 10′ according to the description set forth herein are provided. Apparatus 10 is provided in reverse orientation from apparatus 10′ (i.e., the relative positions of the pipe holding portion 11, 11′ and milling head portion 13, 13′ are reversed. With this reversed arrangement, a thread can be formed at one end of a pipe segment in apparatus 10. Then the pipe segment can be moved to apparatus 10′ to form a thread in the other end of the pipe segment, while at the same time, a second pipe segment is processed in apparatus 10. With this arrangement, therefore, manufacturing throughput can be desirably increased.

It can be appreciated that the pipe segment in chuck 54 effectively acts as a “sun gear,” the thread milling cutters 18 act as “planet carriers,” and the housing 20 can be considered the “ring gear” of the planetary arrangement described above.

Thus, the apparatus provides a self-contained, coaxial thread milling head using multiple cutters with multiple teeth for very high speed thread cutting with low chip load per tooth.

As mentioned above, motors 15, 19, 20, and 40 may, for example, be CNC servo motors. Thus, in an example of the present invention, the motors may be all controlled collectively (such as by a control computer) in order to automate the manufacturing process.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. An apparatus for cutting threads in a pipe end, the apparatus comprising:
a thread milling head including a plurality of milling cutters, each milling cutter being mounted for rotation on an associated shaft and including at least one milling cutter, the milling cutters being constructed and arranged about a central axis to receive the end of a pipe disposed along the central axis, such that the cutters can cut threads in a periphery of the pipe end,
drive means for causing simultaneous rotation of the milling cutters about their associated shafts, and
drive means for causing rotation of the thread milling head about the central axis.

2. The invention as claimed in claim 1 wherein said drive means are provided for each said milling cutter.

3. The invention as claimed in claim 1 wherein a platform is provided for a support member for a pipe end, said platform being movable toward and away from said thread milling head.

4. The invention as claimed in claim 3 wherein said support member includes a rotatable chuck for holding a pipe end and includes a drive for rotating said chuck.

5. The invention as claimed in claim 3 wherein a motor is provided to move said platform toward and away from said thread milling head.

6. The invention as claimed in claim 1 wherein said thread milling head is carried on support which is mounted for vertical movement relative to the central axis.

7. . A thread milling apparatus comprising:
a milling head portion including a plurality of rotatably mounted thread milling cutters arranged about a central axis, and at least one first drive source for driving each said thread milling cutter in rotation; and
a pipe holding portion constructed and arranged to hold a pipe along the central axis such that an end of the pipe is disposed in cooperation with said thread milling cutters, and including a second drive source for rotating the pipe relative to and coaxially with the central axis;
wherein each said thread milling cutter is disposed on an axis located at an angle relative to the central axis.

8. The invention as claimed in claim 1 wherein said drive means are provided for each said milling cutter.

9. The invention as claimed in claim 1 wherein a platform is provided for a support member for a pipe end, said platform being movable toward and away from said thread milling head.

10. The invention as claimed in claim 3 wherein said support member includes a rotatable chuck for holding a pipe end and includes a drive for rotating said chuck.

11. The invention as claimed in claim 3 wherein a motor is provided to move said platform toward and away from said thread milling head.

12. The invention as claimed in claim 1 wherein said thread milling head is carried on support which is mounted for vertical movement relative to the central axis.
